(19) United States
(12) Patent Application Publication
(10) Pub. No.: US 2007/0106719 A1
(43) Pub. Date: May 10, 2007

(54) Integer square root algorithm for use in digital image processing

(75) Inventors: James R. Bailey, Georgetown, KY (US); David A. Crutchfield, Georgetown, KY (US); Zachary N. Fister, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/269,013

(22) Filed: Nov. 8, 2005

(51) Int. Cl. G06F 7/552

(52) U.S. Cl. 708/500

(57) ABSTRACT

An integer square root calculation technique determines the precise root of an input value to determine the distance between data points such as pixels in a digital image. The technique avoids division and floating point multiplication steps. An initial root estimate may be used as a seed value beginning an iterative convergence towards the final solution. A scaled error may be determined by bit shifting an error difference between a square of the root estimate and the input value. Depending on whether the scaled error satisfies a predetermined condition, the current square root estimate may be adjusted by a bit-shifted fraction of the scaled error and the scaled error is then recalculated. In certain instances, a final adjustment to the root estimate may be implemented to yield the precise square root value. Ultimately, the final root estimate may be assigned to an output value representing the desired distance.

### BACKGROUND

The present invention relates generally to digital image processing. More specifically, the present invention relates to an algorithm for determining a precise integer square root applicable in image processing functions. The square root is a mathematical operation that is useful in color science and image manipulation algorithms. For instance, the square root may be useful in calculating the Euclidean distance between any two points in a two or three dimensional space. Distance calculations between pixels may be used in a variety of image processing functions, including for example, red eye reduction, resizing, noise suppression, and other filtering operations. As an example, for a two dimensional image represented by pixels having a range of intensities and unique coordinates, the distance between the pixels may be determined as the square root of the sum of the squared differences between coordinate values. In equation form, distance D may be represented by:
D=\sqrt{(x₂−x₁)²+(y₂−y₁)²} (1)
where the x values are respective x coordinates of two pixels and the y values are respective y coordinates of the same two pixels.

The square root function is often readily available in software implementations of digital image processing operations. Unfortunately, the square root function is not always available in hardware implementations. Some processors may not have native support for the square root function. Further, embedded applications such as Application Specific Integrated Circuits (ASICs) or Digital Signal Processors (DSPs) may be cost prohibitive. Thus, some solutions use an iterative approach often requiring a floating point or integer division operation. However, some economical processors may not even have native support for division operations. Thus, numerical approximations of the division function may be used. The end result may be that each square root operation, which requires several iterations, may require hundreds or thousands of clock cycles per iteration. Some image processing functions require a knowledge of distances between thousands of pixel pairs and may take many seconds to complete. Therefore, existing iterative and numerical approximation methods for the square root function are not optimized for efficient execution of digital image processing functions.

### SUMMARY

The present invention is directed to a technique that uses conventional bit shift, addition, and floating point multiplication operations to arrive at a precise square root of an input value. The technique may be implemented exclusive of any dividers or floating point multipliers. Further, the technique may be used by an image forming device or other computing device to calculate distances between pixels in a digital image. The distance may be a Euclidean spatial distance or a color distance in an orthogonal color space. Given its relative simplicity, the technique may be implemented in software (including embedded and firmware solutions) or hardware designs. For example, square root calculation circuitry may comprise logic circuitry or may comprise a processing device executing embedded instructions.

The technique generally comprises two stages. An input value may be generated by summing the squares of differences between coordinate values for pairs of pixels. Then in the first stage, a root estimate, which may be based upon the number of significant bits in the input value, is generated through bit shifting and adding. The root estimate may then be used as a seed in an iterative second stage that converges on the precise square root of the input value. The second stage calculates a scaled error by bit shifting an error difference between a square of the root estimate and the input value. The iterations stop or continue based upon whether the scaled error is less than or equal to a predetermined threshold. For instance, if the scaled error is greater than the predetermined threshold, the current square root estimate is adjusted by a fraction of the scaled error. Then, the scaled error is recalculated.

Conversely, if the scaled error is less than or equal to the predetermined threshold, the root estimate may be assigned to an output value representing the distance between the pixels. Notably, the magnitudes of the scaled error and the fraction of the scaled error may be generated through bit shifting and may be based in part upon the number of significant bits in the input value. In one embodiment, the scaled error is determined by bit shifting the error difference by about half as many significant bits as the input value. In one embodiment, if the difference between the square of the root estimate and the input value is greater than zero, the final root estimate may be reduced by one prior to assigning the root estimate to the output value representing the distance between the pixels.

### BRIEF DESCRIPTION OF THE DRAWINGS

FIG. 1 is a perspective view of an exemplary computing system in which embodiments of the present invention may be implemented;

FIG. 2 is a functional block diagram of an exemplary computing system in which embodiments of the present invention may be implemented;

FIG. 3 is a schematic representation of a distance measurement that may be calculated using embodiments of the present invention;

FIG. 4 is a diagram of an exemplary computer processing algorithm to implement square root calculations according to one embodiment of the present invention; and

FIG. 5 is a diagram of an exemplary computer processing algorithm to implement square root calculations according to one embodiment of the present invention.

### DETAILED DESCRIPTION

The present invention is directed to embodiments of devices and methods for precisely calculating an integer square root for digital image processing functions. The process may be applied to calculate a distance between pixels of an image and works by implementing conventional processor functions, including addition, multiplication, and bit shifts. Floating point and integer division operations other than bit shift operations are avoided.

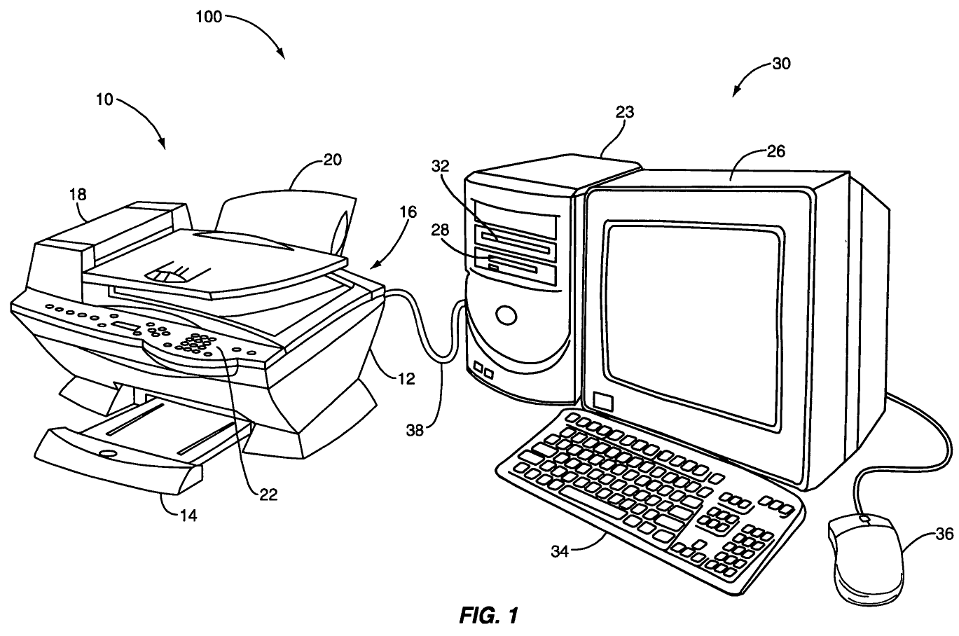

The processing techniques disclosed herein may be implemented in a variety of computer processing systems. For instance, the disclosed square root calculation may be executed by a computing system 100 such as that generally illustrated in FIG. 1. The exemplary computing system 100 provided in FIG. 1 depicts one embodiment of a representative multifunction device, such as an All-In-One (AIO) device, indicated generally by the numeral 10 and a computer, indicated generally by the numeral 30. A multifunction device 10 is shown, but other image forming devices, including laser printers and ink-jet printers are also contemplated. Similarly, a desktop computer 30 is shown, but other conventional computers, including laptop and handheld computers are also contemplated. In the embodiment shown, the multifunction device 10 comprises a main body 12, at least one media tray 20, a flatbed (or feed-through as known in the art) scanner 16 comprising a document handler 18, a media output tray 14, and a user interface panel 22. The multifunction device 10 is adapted to perform multiple home or business office functions such as printing, faxing, scanning, and copying. Consequently, the multifunction device 10 includes further internal components not visible in the exterior view shown in FIG. 1.

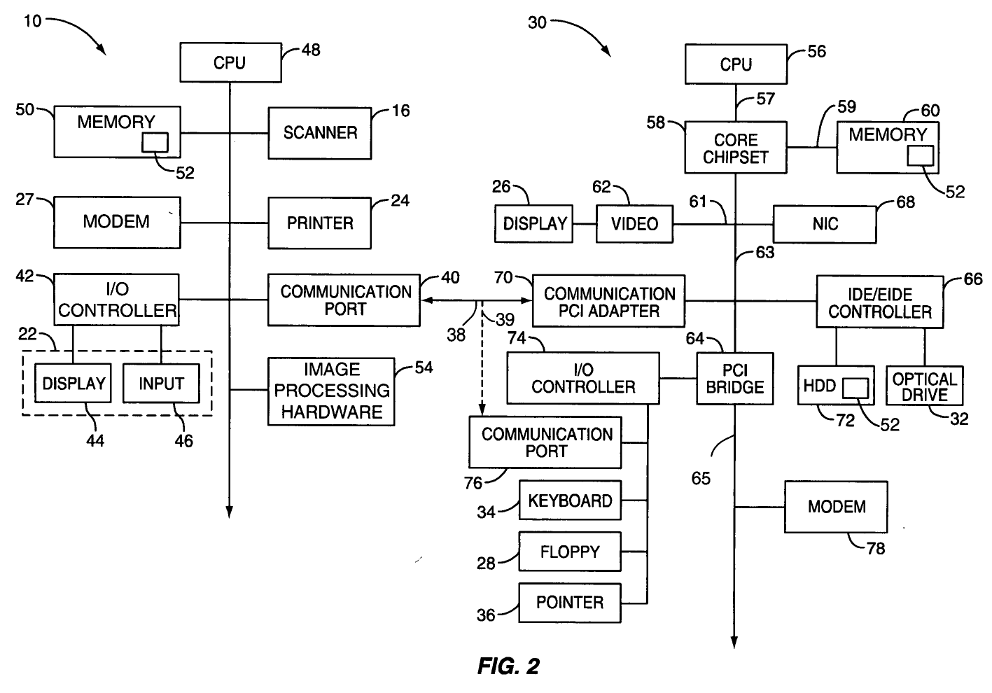

The exemplary computing system 100 shown in FIG. 1 also includes an associated computer 30, which may include a CPU tower 23 having associated internal processors, memory, and circuitry (not shown in FIG. 1, but see FIG. 2) and one or more external media drives. For example, the CPU tower 23 may have a floppy disk drive (FDD) 28 or other magnetic drives and one or more optical drives 32 capable of accessing and writing computer readable or executable data on discs such as CDs or DVDs. The exemplary computer 30 further includes user interface components such as a display 26, a keyboard 34, and a pointing device 36 such as a mouse, trackball, light pen, or, in the case of laptop computers, a touchpad or pointing stick.

An interface cable 38 is also shown in the exemplary computing system 100 of FIG. 1. The interface cable 38 permits one- or two-way communication between the computer 30 and the multifunction device 10. When coupled in this manner, the computer 30 may be referred to as a host computer for the multifunction device 10. Certain operating characteristics of the multifunction device 10 may be controlled by the computer 30 via printer or scanner drivers stored on the computer 30. For instance, print jobs originated on the computer 30 may be printed by the multifunction device 10 in accordance with resolution and color settings that may be set on the computer 30. Where a two-way communication link is established between the computer 30 and the multifunction device 10, information such as scanned images or incoming fax images may be transmitted from the multifunction device 10 to the computer 30.

With regards to the square root calculating techniques disclosed herein, certain embodiments may permit operator control over image processing to the extent that a user may select certain image processing functions that require the square root function. Accordingly, the user interface components such as the user interface panel 22 of the multifunction device 10 and the display 26, keyboard 34, and pointing device 36 of the computer 30 may be used to control various processing parameters. As such, the relationship between these user interface devices and the processing components is more clearly shown in the functional block diagram provided in FIG. 2.

FIG. 2 provides a simplified representation of some of the various functional components of the exemplary multifunction device 10 and computer 30. For instance, the multifunction device 10 includes the previously mentioned scanner 16 as well as an integrated printer 24, which may itself include a conventionally known ink jet or laser printer with a suitable document transport mechanism. Interaction at the user interface 22 is controlled with the aid of an I/O controller 42. Thus, the I/O controller 42 generates user-readable graphics at a display 44 and interprets commands entered at a keypad 46. The display 44 may be embodied as an alphanumeric LCD display and keypad 46 may be an alphanumeric keypad. Alternatively, the display and input functions may be accomplished with a composite touch screen (not shown) that simultaneously displays relevant information, including images, while accepting user input commands by finger touch or with the use of a stylus pen (not shown).

The exemplary embodiment of the multifunction device 10 also includes a modem 27, which may be a fax modem compliant with commonly used ITU and CCITT compression and communication standards such as the ITU-T series V recommendations and Class 1-4 standards known by those skilled in the art. The multifunction device 10 may also be coupled to the computer 30 with an interface cable 38 coupled through a compatible communication port 40, which may comprise a standard parallel printer port or a serial data interface such as USB 1.1, USB 2.0, IEEE-1394 (including, but not limited to 1394a and 1394b) and the like.

The multifunction device 10 may also include integrated wired or wireless network interfaces. Therefore, communication port 40 may also represent a network interface, which permits operation of the multifunction device 10 as a stand-alone device not expressly requiring a host computer 30 to perform many of the included functions. A wired communication port 40 may comprise a conventionally known RJ-45 connector for connection to a 10/100 LAN or a 1/10 Gigabit Ethernet network. A wireless communication port 40 may comprise an adapter capable of wireless communications with other devices in a peer mode or with a wireless network in an infrastructure mode. Accordingly, the wireless communication port 40 may comprise an adapter conforming to wireless communication standards such as Bluetooth®, 802.11x, 802.15 or other standards known to those skilled in the art. A wireless communication protocol such as these may obviate the need for a cable link 38 between the multifunction device and the host computer 30.

The multifunction device 10 may also include one or more processing circuits 48, system memory 50, which generically encompasses RAM and/or ROM for system operation and code storage as represented by numeral 52. The system memory 50 may suitably comprise a variety of devices known to those skilled in the art such as SDRAM, DDRAM, EEPROM, Flash Memory, and perhaps a fixed hard drive. Those skilled in the art will appreciate and comprehend the advantages and disadvantages of the various memory types for a given application.

Additionally, the multifunction device 10 may include dedicated image processing hardware 54, which may be a separate hardware circuit, or may be included as part of other processing hardware. For example, image processing may be implemented via stored program instructions for execution by one or more Digital Signal Processors (DSPs), ASICs or other digital processing circuits included in the processing hardware 54. Alternatively, stored program code 52 may be stored in memory 50, with the image processing techniques described herein executed by some combination of processor 48 and processing hardware 54, which may include programmed logic devices such as PLDs and FPGAs. In general, those skilled in the art will comprehend the various combinations of software, firmware, and hardware that may be used to implement the various embodiments described herein.

FIG. 2 also shows functional components of the exemplary computer 30, which comprises a central processing unit (“CPU”) 56, core logic chipset 58, system random access memory (“RAM”) 60, a video graphics controller 62 coupled to the aforementioned video display 26, a PCI bus bridge 64, and an IDE/EIDE controller 66. The single CPU block 56 may be implemented as a plurality of CPUs 56 in a symmetric or asymmetric multi-processor configuration.

In the exemplary computer 30 shown, the CPU 56 is connected to the core logic chipset 58 through a host bus 57. The system RAM 60 is connected to the core logic chipset 58 through a memory bus 59. The video graphics controller 62 is connected to the core logic chipset 58 through an AGP bus 61 or the primary PCI bus 63. The PCI bridge 64 and IDE/EIDE controller 66 are connected to the core logic chipset 58 through the primary PCI bus 63. A hard disk drive 72 and the optical drive 32 discussed above are coupled to the IDE/EIDE controller 66. Also connected to the PCI bus 63 are a network interface card (“NIC”) 68, such as an Ethernet card, and a PCI adapter 70 used for communication with the multifunction device 10 or other peripheral device. Thus, PCI adapter 70 may be a complementary adapter conforming to the same or similar protocol as communication port 40 on the multifunction device 10. As indicated above, PCI adapter 70 may be implemented as a USB or IEEE 1394 adapter. The PCI adapter 70 and the NIC 68 may plug into PCI connectors on the computer 30 motherboard (not illustrated). The PCI bridge 64 connects over an EISA/ISA bus or other legacy bus 65 to a fax/data modem 78 and an input-output controller 74, which interfaces with the aforementioned keyboard 34, pointing device 36, floppy disk drive (“FDD”) 28, and optionally a communication port such as a parallel printer port 76. As discussed above, a one-way communication link may be established between the computer 30 and the multifunction device 10 or other printing device through a cable interface indicated by dashed lines in FIG. 2.

Relevant to the square root calculation techniques disclosed herein, digital images may be read from a number of sources in the computing system 100 shown. For example, hard copy images may be scanned by scanner 16 to produce a digital reproduction. Alternatively, the digital images may be stored on fixed or portable media and accessible from the HDD 72, optical drive 32, floppy drive 28, or accessed from a network by NIC 68 or modem 78. Further, as mentioned above, the various embodiments of the square root calculation techniques may be implemented in a device driver, program code 52, or software that is stored in memory 50, on HDD 72, on optical discs readable by optical disc drive 32, on floppy disks readable by floppy drive 28, or from a network accessible by NIC 68 or modem 78. Hardware implementations may include dedicated processing hardware 54 that may be embodied as a microprocessor executing embedded instructions or high powered logic devices such as VLSI, FPGA, and other CPLD devices. Those skilled in the art of computers and network architectures will comprehend additional structures and methods of implementing the techniques disclosed herein.

An image from one of the above-described sources may be duplicated, generated, modified, or printed using some user-selected or predetermined processing that requires a square root calculation. The desired image processing may include user-implemented or automated filtering. For example, a user may select a filtering effect or other processing function such as red eye reduction or color conversion prior to printing. As another example, the multifunction device 10 may perform some image manipulation, such as edge sharpening or median filtering according to a preconfigured setting while printing an image or an incoming fax. Some processing functions require calculation of a standard deviation value for data sets that include data such as pixel intensities. These and other exemplary processing functions known to those skilled in the art may require square root calculations.

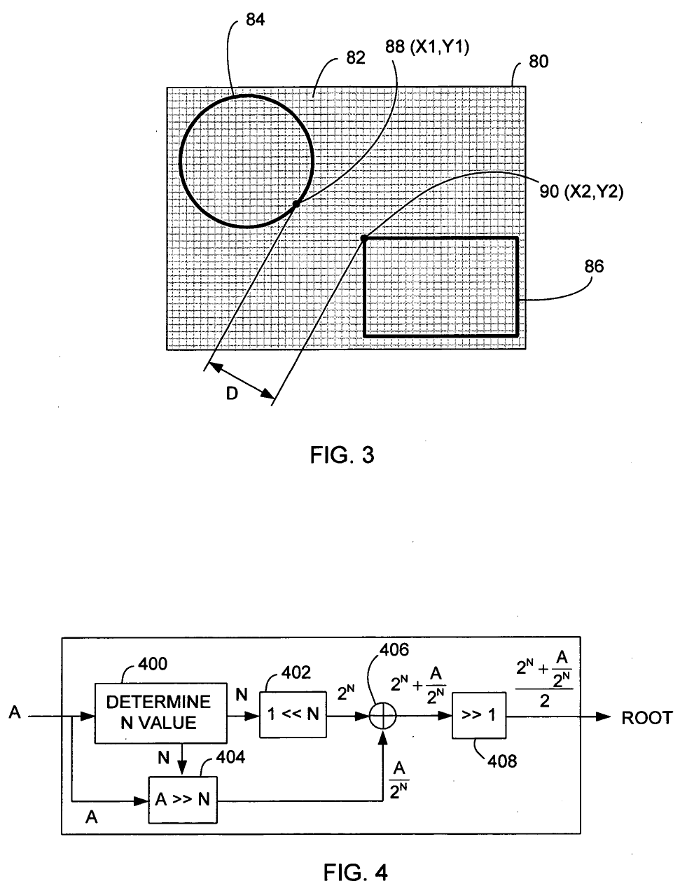

One specific example of such processing includes a spatial distance calculation as graphically represented in FIG. 3. FIG. 3 shows an exemplary image 80 comprising a plurality of pixels 82. In general, each pixel 82 represents a unique position in coordinate space. Further each pixel 82 may have a color intensity value that is defined by a desired color space and color depth. For example, a grayscale image having a color depth of 8 bits per pixel may have up to 256 gray levels associated with each pixel. Color images may have pixel intensities representing color components (e.g., an RGB model), intensity/chroma components (e.g., YCrCb and HSB models), or other components representing other models known in the art of color science.

In the exemplary image 80 shown in FIG. 3, a distance D between two data points associated with the digital image can be calculated using equation (1), which is reproduced below.
D=\sqrt{(x₂−x₁)²+(y₂−y₁)²} (1)
For example, the distance D can be calculated between objects 84, 86. More accurately, the distance D can be calculated between two pixels 88, 90 forming a portion of objects 84, 86. In FIG. 3 and equation (1), the values x₁ and y₁ define a coordinate position of a first pixel 88 while values x₂ and y₂ define a coordinate position of a second pixel 90. As indicated above, a variety of image processing functions may require a square root calculation. For instance, red eye reduction, resizing, noise suppression, and other filtering operations may perform multiple distance calculations. Furthermore, spatial distance measurements may be calculated in three dimensions for three-dimension graphics and video applications. In addition to spatial distance measurements, color distance measurements may be calculated, particularly where an orthogonal color space is used to identify pixel intensities in an image. Thus, D may represent a distance between color data points. Accordingly, equation (1) may be generally expanded to include a third z-dimension according to equation (2).
D=\sqrt{(x₂−x₁)²+(y₂−y₁)²+(z₂−z₁)²}=\sqrt{A} (2)
where A simply represents the input operand. In the given distance measurement examples, A represents the sum of the squares of the differences between respective pixel coordinate values (spatial, color, or otherwise).

A two-stage process may be used to calculate the distance D between pixels 88, 90 in an image 80. A first stage of the square root calculation technique is loosely based upon a known convergence algorithm. In the known convergence algorithm, a first guess value x(i) is selected such that x(i)² is close to the square root of A. In one example, x(i) is slightly less than the square root of A and the quotient A/x(i) is slightly larger than the square root of A. The average of these two quantities x(i+1) approaches the actual square root and is represented as

$$x ( i + 1 ) = \frac{x ( i ) + \frac{A}{x ( i )}}{2} . \qquad ( 3 )$$

In the known convergence algorithm, this calculation is repeated until x(i+1)−x(i) equals 0 or falls below some predetermined threshold. One disadvantage present with equation (3) is that the quotient A/x(i) requires a floating point or integer division operation. To eliminate this problem, a variation of equation (3) may be used to generate a seed value that is used in a second stage of the present square root calculation technique.
Stage 1

The first stage of the present square root calculation technique generates a seed value that is used in a second stage, described below. The second stage produces an accurate integer square root value through an iterative process that is achieved without the use of any division (floating point or integer) or floating point multiplication. In this first stage, the known convergence algorithm discussed above is modified for a single iteration according to the following

$$ROOT = \frac{{2}^{N} + \frac{A}{{2}^{N}}}{2} \qquad ( 4 )$$

where N is some integer value and ROOT is the seed value. In one embodiment, N may be determined based upon the size of A. Each division operation in the equation (4) includes a divisor that is some power of the number 2. Division by a power of two can be executed by performing a bit shift of the binary representation of the numerator, with the number of shifts equal to the power number. For example, division by 8 (which equals 2 to the power 3) may be executed by performing a three place bit shift to the right. Accordingly, FIG. 4 shows a block diagram illustrating the mathematical manipulations that are executed to arrive at a seed value ROOT from the input value A.

In FIG. 4, the technique for generating the seed value ROOT from the input value A begins at block 400 where N is determined. As suggested above, N may be based upon the size of the input value A. In general, for binary representations of the relevant numbers, the square root of an input value A will have approximately half as many significant bits as the input value A. Thus, in one embodiment, N may be determined according to:

$$N = \frac{{MSB}_{A}}{2} \qquad ( 5 )$$

where MSB_{A} is simply the most significant bit of the input value A. Since only the most significant bit of the input value is considered, Equation (5) may produce a low estimate (i.e., the quantity 2^{N}) for the ROOT value. Thus, other embodiments may account for this by slightly increasing the value of N. For instance, a generic variation is given by:

$$N = \frac{{MSB}_{A} + M}{2} \qquad ( 6 )$$

where M is some integer value such as 1, 2, 3, etc. . . . In yet another embodiment, N may be given by:

$$N = \frac{{MSB}_{A}}{2} + M \qquad ( 7 )$$

where M is once again some integer value such as 1, 2, 3, etc. . . . For any of these equations (5), (6), and (7), those skilled in the art of digital logic design will comprehend that only a small amount of combinational logic may be needed to generate the value for N based upon the input value A. In at least one embodiment, a value of M=1 in equation (6) has yielded satisfactory results over a sizable range of input values A. In fact, statistical analysis has shown that the resulting approximation was determined to be within an average error of 1.7% from the actual square root value using a 16-bit approximation circuit implementing the process outlined in FIG. 4. Of course, different equations and different values for the variable M may be used for different size input values A.

Having determined a suitable value for N in block 400 of FIG. 4, separate paths are taken to generate two separate quantities. In block 402, the binary representation of the number 1 is left shifted by N bits (i.e., multiplied by 2^{N}) to produce the quantity 2^{N}. In a parallel block 404, the binary representation of the input number A is right shifted by N bits (i.e., divided by 2^{N}) to produce the quotient A/2^{N}. In step 406, these two quantities are added to produce the numerator that is found in equation (4) above. Ultimately, in step 408, this numerator value is right shifted by 1 bit (i.e., divided by 2) to produce the ROOT seed as given by the expression in equation (4). This value is then used as a starting point in the second stage of the algorithm. This first stage of the square root calculation algorithm may be implemented using a hardware design comprising binary data registers and adders, and executed using simple bit shift operations.

Stage 2

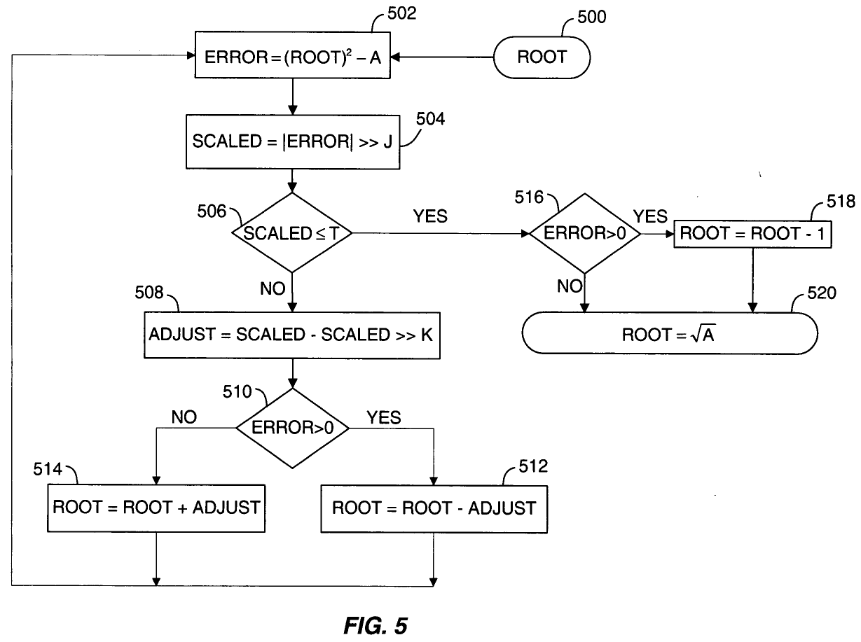

The second stage of the present square root calculation technique produces an accurate integer square root value through an iterative process that is achieved without the use of any division (other than bit shifts) or floating point multiplication. The second stage of the algorithm uses an iterative approach to narrow in on the precise integer square root of the input value A. This algorithm is illustrated in FIG. 5. Using the seed determined in the first stage (input value 500), the initial error for the approximate square root (ROOT) can be represented (step 502) by:
ERROR=(ROOT)²−A. (8)

As with any successful iteration approach, successive estimates for the root estimate ROOT should converge to the actual root value so that the Error converges towards zero. Unfortunately, in an integer square root calculation process, this error equation may not always converge to zero. This is because the algorithm truncates the fractional portion of a mathematical result. Without a definite convergence, the iterative second stage may simply enter an infinite loop where the solution toggles between two approximate solutions. To overcome this problem, the following scaled error value SCALED (step 504 in FIG. 5) may be used:

$$SCALED = \frac{\vert ERROR \vert}{{2}^{J}} \qquad ( 9 )$$

where J is some integer value. In one or more embodiments, the value of J may be similar to the variable N described above in that J is based upon the size of the input value A. Thus, J may be determined according to any one of equations (5), (6), or (7) provided above. In one embodiment, successful results may be achieved using m=2 in the expression provided in equation (6). As above, other ranges of input values may call for different values of the variable J.

Notably, the J and SCALED terms are computed using adders and bit shift operations in keeping with the desire to avoid division operations. In this iterative second stage, the scaled error value (SCALED) converges to or below some predetermined threshold T, even with truncation errors that occur in integer processing, as successive root estimates approach the actual square root of A. In one embodiment, with J properly sized, the SCALED term converges to zero. If SCALED has not converged to the desired threshold, the previous estimate of the square root (ROOT) is adjusted and the process repeated. This decision step is represented by reference number 506 in FIG. 5.

The algorithm continues by modifying the previous square root estimate ROOT by an amount that depends on whether the previous estimate was larger or smaller than the desired result. More specifically, if ERROR was positive, the root estimate ROOT is reduced. Conversely, if ERROR was negative, the root estimate ROOT is increased. Efficient results may be obtained by using an adjustment term ADJUST (step 508 in FIG. 5) defined by:

$$ADJUST = SCALED - \frac{SCALED}{{2}^{K}} \qquad ( 10 )$$

where K is some integer value. For example, values of K=1, K=2, or K=3 may be appropriate and produce adjustment terms ADJUST that are approximately ½, ¾, and ⅞ of the SCALED term, respectively. These are approximate ratios because truncation may not yield precise ratios between ADJUST and SCALED. For square root calculations used in determining spatial distances between pixels in a digital image, a value of K=2 may be suitable. Other values for K may be appropriate if distances other than spatial distances are calculated. The modified adjustment term ADJUST is added or subtracted to the most recent root approximation (ROOT). If ERROR is positive (determined at decision step 510), indicating that the root approximation is too large, the ADJUST term is subtracted from the ROOT approximation (step 512).
ROOT=ROOT−ADJUST (11)
Conversely, if ERROR is negative (also determined at step 510), indicating that the root approximation is too small, the ADJUST term is added to the ROOT approximation (step 514).
ROOT=ROOT+ADJUST (12)
Then, the adjusted ROOT value is fed back (in step 502) into Equation (8) and the process repeated until the value for SCALED generated by Equation (9) and step 504 is less than or equal to the predetermined threshold T (determined at decision step 506).

Once the value for SCALED reaches this threshold T, the iterative process is complete. However, one additional step may be necessary for those cases where ERROR>0 (as determined in step 516). The SCALED term may be zero indicating that the convergence algorithm is complete. However, a positive value for ERROR results from an error correction that is undetectable by the SCALED term produced by Equation (9). In this case, ERROR generally equals 1 and the final value for ROOT is simply reduced by one (step 518). The same correction is unnecessary for cases when ERROR<0 (determined at step 516) because the integer root is truncated down to the next largest integer.

The square root value generated at final step 520 is a precise integer value with the fractional portion truncated. The processing required for the square root calculation technique disclosed herein is minimized by eliminating a true division operation. The division operations listed in the equations above are by a power of 2, so they can be performed by simple bit shifting in hardware, software, or embedded implementations. Multiplication operations are held to a minimum and are implemented only in equations (2) and (8) above. Since the multiplications performed by these equations are executed at different times, a common multiplier, such as a 16-bit multiplier depending on the expected size of A, and a simple multiplexing device may be used to perform the “squaring” operation. Bit shifting data in data registers is known and is a commonly supported processor command. Further, those skilled in the art of binary data manipulation, use of the two's complement of binary values permits unification of the circuitry for addition and subtraction. Thus, the square root calculation techniques may be effectively implemented in a hardware-only logic circuit. Statistical analysis has shown that for a 31-bit integer input value, an average of about 4-5 iterations is required to obtain the precise integer square root value. Each iteration requires a variable number of clock cycles depending on process technology or desired performance. The advantages of a hardware-only implementation do not preclude application in software or firmware embodiments. For any of these applications, the elimination of a true division calculation may improve performance in systems that perform frequent image calculations.

Exemplary Illustration

The present square root calculation technique may be illustrated using a numerical example. Let the input number A=37376 (decimal)=9200 (hex)=1001 0010 0000 0000 (binary). Recognizing that the most significant non-zero bit is 15 (counting from the zero bit location at the far right), equation (6) above with M=1 reduces to:

$$N = \frac{{MSB}_{A} + M}{2} = ( \frac{15 + 1}{2} ) = \frac{16}{2} = 8. \qquad ( 6 a )$$

Then, using this value for N, equation (4) and FIG. 4 reduces to:

$$ROOT = \frac{{2}^{N} + \frac{A}{{2}^{N}}}{2} = \frac{{2}^{8} + \frac{37376}{{2}^{8}}}{2} = 201. \qquad ( 4 a )$$

This value is then used as a starting point in the second stage of the algorithm.

As discussed above, the second stage of the square root calculation algorithm uses an iterative approach. Each of these iterations for the present numerical example is provided, in turn, below. For the sake of completeness, assume an exemplary value of M=2 in the expression given in equation (6) to calculate J. Thus, J=(15+2)/2=8. Also let K=2 in equation (10) and let the predetermined threshold T=0.

$$\begin{matrix}Iteration 1 & \\ ERROR = {( ROOT )}^{2} - A = {( 201 )}^{2} - 37376 = 3025 , which > 0 ; & ( 8 a ) \\ SCALED = \frac{\vert ERROR \vert}{{2}^{J}} = \frac{\vert 3025 \vert}{{2}^{8}} = 11 , which \neq 0 ; & ( 9 a ) \\ ADJUST = SCALED - \frac{SCALED}{{2}^{K}} = 11 - \frac{11}{4} = 11 - 2 = 9 ; and & ( 10 a ) \\ ROOT = ROOT - ADJUST = 201 - 9 = 192. \\ Iteration 2 & ( 11 a ) \\ ERROR = {( ROOT )}^{2} - A = {( 192 )}^{2} - 37376 = - 512 , which < 0 ; & ( 8 b ) \\ SCALED = \frac{\vert ERROR \vert}{{2}^{J}} = \frac{\vert - 512 \vert}{{2}^{8}} = 2 , which \neq 0 ; & ( 9 b ) \\ ADJUST = SCALED - \frac{SCALED}{{2}^{K}} = 2 - \frac{2}{4} = 2 - 0 = 2 ; and & ( 10 b ) \\ ROOT = ROOT + ADJUST = 192 + 2 = 194. \\ Iteration 3 & ( 12 b ) \\ ERROR = {( ROOT )}^{2} - A = {( 194 )}^{2} - 37376 = 260 , which > 0 ; & ( 8 c ) \\ SCALED = \frac{\vert ERROR \vert}{{2}^{J}} = \frac{\vert 260 \vert}{{2}^{8}} = 1 , which \neq 0 ; & ( 9 c ) \\ ADJUST = SCALED - \frac{SCALED}{{2}^{K}} = 1 - \frac{1}{4} = 1 - 0 = 1 ; and & ( 10 c ) \\ ROOT = ROOT - ADJUST = 194 - 1 = 193. \\ Iteration 4 & ( 11 c ) \\ ERROR = {( ROOT )}^{2} - A = {( 193 )}^{2} - 37376 = - 127 , which < 0 ; & ( 8 d ) \\ SCALED = \frac{\vert ERROR \vert}{{2}^{J}} = \frac{\vert - 127 \vert}{{2}^{8}} = 0. & ( 9 d )\end{matrix}$$

Since the value of SCALED has reached zero, the iteration stops. Also, since ERROR is negative, there is no need to subtract 1 from the final ROOT value of 193. By way of comparison, the actual square root of 37376 is 193.33, which truncates to 193 for integer operations. Thus, the illustrated example shows that the square root calculation algorithm produces an accurate result.

The present invention may be carried out in other specific ways than those herein set forth without departing from the scope and essential characteristics of the invention. For instance, a few representative values for the adjustable variables M, J, and K were provided in the embodiments described above. Each of these variables may be adjusted as needed to fit a particular implementation. For example, the adjustment term ADJUST produced by equation (10) provided above is essentially a modified SCALED term, reduced by the quotient SCALED/2^{K}. An alternative embodiment may use a very large value for K to make the quotient disappear. Thus, ADJUST simply reduces to SCALED. Other variations to the equations presented above may be feasible. Accordingly, the present embodiments are to be considered in all respects as illustrative and not restrictive, and all changes coming within the meaning and equivalency range of the appended claims are intended to be embraced therein.

What is claimed is:

1. A method of calculating an integer square root of an input value to determine a distance between data points in a digital image, the method comprising:
determining a precise integer square root of an input value representing a sum of squares of differences between coordinate values for a pair of data points associated with the digital image through steps comprising bit shifting, integer multiplying, and integer adding exclusive of any dividing or floating point multiplying.

2. The method of claim 1 wherein the distance is a spatial distance.

3. The method of claim 1 wherein the distance is a color distance.

4. The method of claim 1 wherein the step of determining a precise integer square root of an input value further comprises:
calculating a square root estimate of the input value;
calculating a scaled error based in part on an error difference between a square of the current square root estimate and the input value;
determining if the scaled error is less than or equal to a predetermined threshold;
if the scaled error is greater than the predetermined threshold, adjusting the current square root estimate by a scaled adjustment value and recalculating the scaled error; and
if the scaled error is less than or equal to the predetermined threshold, assigning the current square root estimate to an output value representing the distance.

5. The method of claim 4 wherein the magnitudes of the scaled error and the scaled adjustment value are based in part upon the number of significant bits in the input value.

6. The method of claim 4 further comprising if the difference between the square of the current square root estimate and the input value is greater than zero, subtracting one from the current square root estimate assigned to the output value representing the distance.

7. The method of claim 4 wherein calculating a scaled error based in part on an error difference between a square of the current square root estimate and the input value comprises dividing the error difference by a scaling variable that is some power of two.

8. The method of claim 7 wherein the scaling variable comprises about half as many significant bits as the input value.

9. The method of claim 4 further comprising setting the scaled adjustment value to a magnitude that is smaller than the scaled error by equating the scaled adjustment value to the scaled error reduced by a quotient of the scaled error divided by a power of two.

10. A method of calculating an integer square root value to determine a distance value in a digital image, the method comprising:
generating an input value by summing the squares of differences between coordinate values for a pair of data points associated with the digital image;
calculating a current square root estimate of the input value based at least partly on the number of significant bits in the input value;
calculating a scaled error based in part on an error difference between a square of the current square root estimate and the input value;
determining if the scaled error is less than or equal to a predetermined threshold;
if the scaled error is greater than the predetermined threshold, adjusting the current square root estimate by a scaled adjustment value and recalculating the scaled error; and
if the scaled error is less than or equal to the predetermined threshold, assigning the current square root estimate to an output value representing the distance.

11. The method of claim 10 wherein the magnitudes of the scaled error and the scaled adjustment value are based in part upon the number of significant bits in the input value.

12. The method of claim 10 further comprising if the difference between the square of the current square root estimate and the input value is greater than zero, subtracting one from the current square root estimate to the output value representing the distance.

13. The method of claim 10 wherein the distance is a spatial distance.

14. The method of claim 10 wherein the distance is a color distance.

15. The method of claim 10 wherein calculating a scaled error based in part on an error difference between a square of the current square root estimate and the input value comprises dividing the error difference by a scaling variable that is some power of two.

16. The method of claim 15 wherein the scaling variable comprises about half as many significant bits as the input value.

17. The method of claim 10 further comprising setting the scaled adjustment value to a magnitude that is smaller than the scaled error.

18. The method of claim 17 wherein setting the scaled adjustment value to a magnitude that is smaller than the scaled error comprises equating the scaled adjustment value to the scaled error reduced by a quotient of the scaled error divided by a power of two.

19. The method of claim 10 wherein determining if the scaled error is less than or equal to a predetermined threshold comprises determining if the scaled error equals zero.

20. A method for transforming a digital image, including generating a precise integer square root of data extracted from said digital image, the method comprising:
determining a square root approximation for the data;
calculating an error of the approximation;
calculating a scaled error value by scaling the error by a power of two;
iteratively correcting the square root approximation until the scaled error satisfies a predetermined condition thus indicating a precise square root result; and
transforming the digital image in response to the indicated precise square root result.

21. The method of claim 20 wherein the precise square root calculation is used to determine a spatial distance.

22. The method of claim 20 wherein the square root calculation is used to determine a color distance.

23. The method of claim 20 wherein the square root calculation is used to determine a standard deviation.

24. The method of claim 20 wherein the image data represents a two-dimensional image.

25. The method of claim 20 wherein the image data received represents a three-dimensional image.

26. The method of claim 20 wherein the scaled error is based in part upon the number of significant bits in the data extracted from said digital image.

27. A computer processing device comprising:
square root calculation circuitry to determine a distance value between data points in a digital image,
the square root calculation circuitry adapted to iteratively determine a precise integer square root of an input value representing a sum of the squares of differences between coordinate values for a pair of data points associated with the digital image using bit shifts, integer multipliers, and integer adders exclusive of any dividers or floating point multipliers.

28. The computer processing device of claim 27 wherein the distance is a color distance.

29. The computer processing device of claim 27 wherein the distance is a spatial distance.

30. The computer processing device of claim 27 wherein the square root calculation circuitry comprises logic circuitry.

31. The computer processing device of claim 27 wherein the square root calculation circuitry comprises a processing device executing embedded instructions.

32. The computer processing device of claim 27 wherein the square root calculation circuitry comprises an application specific integrated circuit in an image forming device.
